(19) United States
(12) Patent Application Publication
(10) Pub. No.: US 2018/0331331 A1
(43) Pub. Date: Nov. 15, 2018

(54) ELECTRICAL STORAGE DEVICE

(71) Applicant: KABUSHIKI KAISHA TOYOTA JIDOSHOKKI, Kariya-shi, Aichi-ken (JP)

(72) Inventors: Atsushi MINAGATA, Kariya-shi (JP); Masato OGASAWARA, Kariya-shi (JP); Tomoaki TACHIBANA, Kariya-shi (JP); Takashi TSUTSUI, Kariya-shi (JP)

(73) Assignee: KABUSHIKI KAISHA TOYOTA JIDOSHOKKI, Kariya-shi, Aichi-ken (JP)

(21) Appl. No.: 15/774,215

(22) PCT Filed: Sep. 6, 2016
(86) PCT No.: PCT/JP2016/076155

§ 371 Date: May 7, 2018

(30) Foreign Application Priority Data
Nov. 9, 2015 (JP) PCT/JP2015/081449

(51) Int. Cl. H01M 2/04; H01M 2/02; B23K 26/21; H01M 2/08

(52) U.S. Cl. CPC H01M 2/043; H01M 2/024; H01M 2220/20; H01M 2/08; H01M 2/0473; B23K 26/21

(57) ABSTRACT

A case of an electrical storage device includes a case body, a lid, and a welded portion at an abutting portion where the case body and the lid are abutting against each other. In a cross-sectional view of the case along its extending direction, the welded portion has an interface existing at a boundary of the welded portion with the case body and the lid. The maximum dimension from an exposed surface of the welded portion to the interface is defined as a weld depth X. The dimension from the abutting portion to an edge of the welded portion in a direction along the exposed surface of the welded portion is defined as a weld width Y. The welded portion is configured to exist over the entire circumference of the case in a shape that satisfies an expression Y/X>1.

### TECHNICAL FIELD

The present invention relates to an electrical storage device including a case having a welded portion.

### BACKGROUND ART

Vehicles such as electric vehicles (EV) and plug-in hybrid vehicles (PHV) are equipped with rechargeable batteries such as lithium-ion rechargeable batteries, which are electrical storage devices that store electricity to be supplied to motors, which are driver sources. For example, the case of the sealed battery (rechargeable battery) of Patent Document 1 includes an aluminum case body member (case body), which accommodates an electrode body (electrode assembly), a sealing lid, which closes the opening of the case body, and a welded portion, which welds the case body member and the sealing lid to each other.

### PRIOR ART DOCUMENT

### Patent Document

Patent Document 1: Japanese Laid-Open Patent Publication No. 2012-104414

### SUMMARY OF THE INVENTION

### Problems that the Invention is to Solve

Electrode assemblies have positive electrodes and negative electrodes, which are stacked alternately. As an electrode assembly is repeatedly charged and discharged, the electrode assembly repeats expansion and contraction in the stacking direction of the electrodes. This repeatedly generates stress in the stacking direction of the electrode assembly in the case. Also, when gas is generated in the case by the reaction between the electrolytic solution and the active material, the internal pressure of the case increases, which generates stress in the case. Therefore, in a rechargeable battery, stress is generated in the welded portion of the case due to repetitive charging and discharging of the electrode assembly and an increase in the internal pressure of the case. This may damage the welded portion may be.

Accordingly, it is an objective of the present invention to provide an electrical storage device capable of increasing the strength of the welded portion of the case.

### Means for Solving the Problems

To achieve the foregoing objective, an electrical storage device is provided that includes an electrode assembly and a case, which accommodates the electrode assembly. The case includes a tubular case body, which has a bottom wall and an opening, and a lid, which closes the opening. The case body has a case-side mating surface, which abuts against the lid. The lid has a lid-side mating surface, which faces the case-side mating surface. The case has a welded portion at an abutting portion, which is a portion where the case-side mating surface and the lid-side mating surface are abutting against each other. A direction that connects the bottom wall of the case body and the lid by the shortest distance is defined as an extending direction of the case. In a cross-sectional view of the case along the extending direction, the welded portion has an interface existing at a boundary of the welded portion with the case body and the lid. A maximum dimension from a surface of the welded portion exposed from an outer surface of the case to the interface is defined as a weld depth X. A dimension from the abutting portion to an edge of the welded portion in a direction along the surface of the welded portion exposed from the outer surface of the case is defined as a weld width Y. The welded portion is configured to exist over an entire circumference of the case in a shape that satisfies an expression Y/X>1.

With this configuration, the welded portion is configured such that the weld width Y is greater than the weld depth X at any location in the circumferential direction of the case. As a comparative example, a welded portion is assumed in which the weld depth X is the same as the above-described configuration and the weld width Y is smaller than the weld depth X. In this case, the welded portion of the above-described configuration can make the length of the interface of the welded portion longer than that of the comparative example. As the length of the interface increases, the volume of the welded portion increases. Accordingly, the load per unit area on the welded portion is reduced as compared with the comparative example. This increases the strength of the welded portion as compared with that of the comparative example.

In the electrical storage device, the weld depth X is preferably a dimension at the case-side mating surface and the lid-side mating surface, and the interface is preferably orthogonal to the case-side mating surface and the lid-side mating surface at a section passing through the abutting portion.

With this configuration, in the cross-sectional view along the extending direction, when the interface is oblique to the case-side mating surface and the lid-side mating surface at the section passing through the abutting portion, the smaller the angle of the interface with respect to the mating surfaces, the smaller the weld width becomes. The length of the interface decreases, accordingly. However, since the interface is orthogonal to the case-side mating surface and the lid-side mating surface at the section passing through the abutting portion, it is possible to prevent the weld width from being reduced, thereby increasing the strength of the welded portion.

In the electrical storage device, the welded portion preferably includes a first edge, which is exposed from an outer surface of the lid, and a second edge, which is exposed from an outer surface of the case body. The interface extends arcuately between the first edge and the second edge.

When the interface is bent near the case-side mating surface and the lid-side mating surface in the cross-sectional view along the extending direction of the case, the interface obliquely intersects with the case-side mating surface and the lid-side mating surface. The smaller the angle at which the interface intersects with the mating surfaces, the smaller the weld width and the length of the interface become. However, since the interface extends arcuately between the edges on the opposite sides of the welded portion, it is possible to prevent the weld width from being reduced, thereby increasing the strength of the welded portion.

In the electrical storage device, in a cross-sectional view taken along the extending direction of the case, the welded portion preferably has a semi-elliptical shape elongated in the extending direction.

In the electrical storage device, the case body includes a circumferential wall, and the circumferential wall has an opening end face, which surrounds the opening, and an outer circumferential surface. The opening end face has the case-side mating surface. The lid includes an inner end face, which has the lid-side mating surface, and an outer circumferential surface, which surrounds the inner end face. The surface of the welded portion is exposed from the outer circumferential surface of the circumferential wall and the outer circumferential surface of the lid. The weld depth of the welded portion is a dimension in a thickness direction of the circumferential wall.

This configuration ensures the weld width in the extending direction of the case and the weld depth in the thickness direction of the circumferential wall of the case body. Therefore, it is unnecessary to ensure the weld width in the thickness direction of the circumferential wall of the case body, and it is possible to prevent the energy density of the electrical storage device from being reduced due to an increase in the thickness of the circumferential wall.

In the electrical storage device, the electrode assembly has stacked electrodes of different polarities, and the electrical storage device is one of a plurality of electrical storage devices, which are restrained in a state of being arranged in a stacking direction of the electrodes.

As the electrode assembly is repeatedly charged and discharged, the electrode assembly repeats expansion and contraction in the stacking direction. However, since the electrical storage device is restrained in the stacking direction of the electrode assembly, deformation caused by the load due to expansion and contraction of the electrode assembly is limited, and the welded portion is unlikely to be damaged in the stacking direction of the electrode assembly. On the other hand, since deformation of the electrode assembly in the stacking direction is limited when the internal pressure of the case increases, the load applied to the case in the extending direction is not limited. Accordingly, the lid receives a load in a direction away from the case body. However, since a sufficient weld width along the extending direction of the case is ensured and the length of the interface is also elongated, the welded portion is unlikely to be damaged even in the direction away from the case body.

Particularly, in a case having a welded portion in which the weld width is ensured in the extending direction of the case, when the internal pressure of the case increases and the lid receives a load in a direction away from the case body, the case receives a force in the direction of shearing the interface of the welded portion. However, since the length of the interface is increased, the welded portion is unlikely to be damaged in a direction in which the lid separates from the case body even if a force in the shearing direction is applied.

In the electrical storage device, the case body has a circumferential wall, which has an opening end face surrounding the opening and an inner circumferential surface including the case-side mating surface. The lid has an outer end face and an outer circumferential surface surrounding the outer end face and having the lid-side mating surface. The surface of the welded portion is exposed from the opening end face and the outer end face. The weld depth of the welded portion is a dimension in the extending direction.

As the electrode assembly is repeatedly charged and discharged, the electrode assembly repeats expansion and contraction. However, since a weld width is ensured in the stacking direction of the electrode assembly and the length of the interface is increased, the welded portion is unlikely to be damaged.

In the electrical storage device, the case body has a circumferential wall. A dimension in a thickness direction of the circumferential wall is defined as a thickness D1. A dimension of the lid along the extending direction is defined as a thickness D. The case body and the lid may be configured to satisfy an expression D>D1.

By making the thickness D of the lid greater than the thickness D1 of the circumferential wall, a sufficient weld width of the welded portion is ensured in the extending direction of the case. This ensures a sufficient weld strength without increasing the thickness of the circumferential wall. Therefore, it is possible to prevent the energy density of the electrical storage device from being reduced due to an increase in the thickness of the circumferential wall.

The electrical storage device is, for example, a rechargeable battery.

### Effects of the Invention

The present invention increases the strength of the welded portion of the case.

### BRIEF DESCRIPTION OF THE DRAWINGS

FIG. 1 is an exploded perspective view illustrating a rechargeable battery according to a first embodiment.

FIG. 2 is a perspective view illustrating the electrical storage module according to the first embodiment.

FIG. 3A is a partial cross-sectional view illustrating a welded portion in the case of the first embodiment.

FIG. 3B is a partial cross-sectional view illustrating a welded portion in a comparison example.

FIG. 4 is a partial cross-sectional view illustrating a welded portion in the case of a second embodiment.

FIG. 5 is a partial cross-sectional view illustrating a welded portion in the case of a third embodiment.

FIG. 6 is a partial cross-sectional view illustrating a welded portion in the case of a fourth embodiment.

FIG. 7 is a partial cross-sectional view illustrating a welded portion in the case of a fifth embodiment.

FIG. 8 is a partial cross-sectional view illustrating a welded portion in the case of a sixth embodiment.

FIG. 9 is a partial cross-sectional view illustrating a welded portion in the case of a seventh embodiment.

FIG. 10 is a partial cross-sectional view illustrating a welded portion in the case of an eighth embodiment.

### MODES FOR CARRYING OUT THE INVENTION

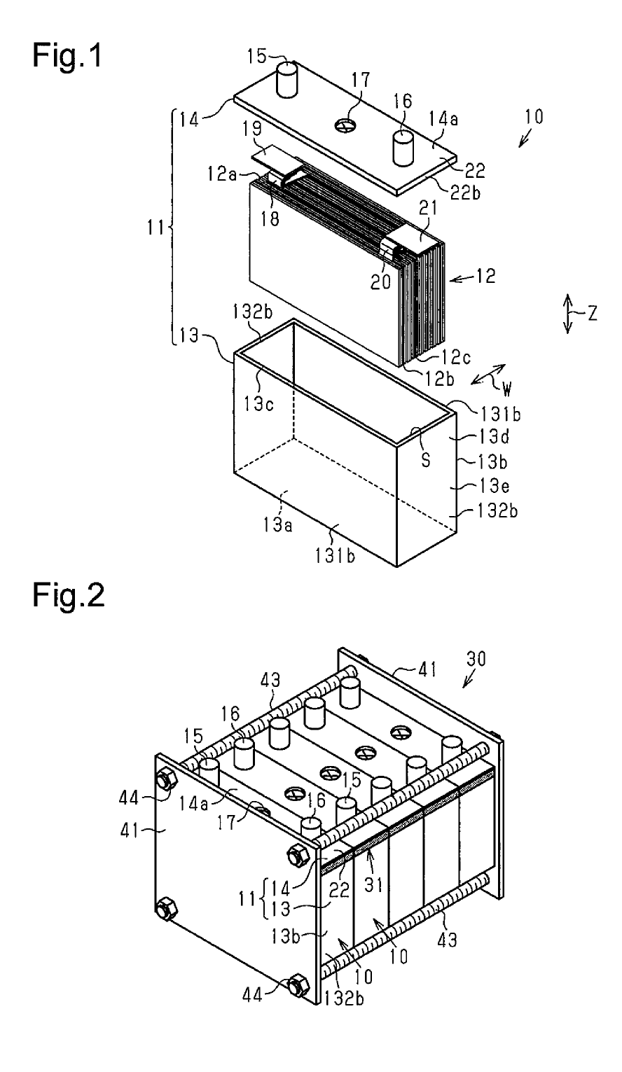

An electrical storage device according to a first embodiment will now be described with reference to FIGS. 1 to 3B.

As shown in FIG. 1, a rechargeable battery 10, which is an electrical storage device, has a case 11, which accommodates an electrode assembly 12. The case 11 has a rectangular parallelepiped-shaped case body 13, which has a bottom wall 13a and an opening S, and a rectangular flat plate-shaped lid 14, which closes the opening S of the case body 13. The case body 13 has a rectangular tubular shape. The case body 13 and the lid 14 are both made of metal (for example, stainless-steel or aluminum). Also, the rechargeable battery 10 of the present embodiment is a prismatic battery having a rectangular parallelepiped-shaped appearance. The rechargeable battery 10 of the present embodiment is a lithium-ion battery.

The electrode assembly 12 has positive electrodes 12a, negative electrodes 12b, and separators 12c. The separators 12c respectively insulate the positive electrodes 12a from the negative electrodes 12b. Each positive electrode 12a has a rectangular shape with long sides and short sides and includes a sheet of positive-electrode foil (for example, aluminum foil) and positive-electrode active material layers provided on the opposite sides of the sheet of positive-electrode foil. Each negative electrode 12b has a rectangular shape with long sides and short sides and includes a sheet of negative-electrode foil (for example, copper foil) and negative-electrode active material layers provided on the opposite sides of the sheet of negative-electrode foil.

The electrode assembly 12 has a stacking structure, in which the positive electrode 12a and the negative electrode 12b are alternately stacked in one direction such that the active material layers of each adjacent pair of the positive electrodes 12a and the negative electrodes 12b face each other, and each separator 12c is located between an adjacent pair of the electrodes 12a and 12b. The separators 12c are microporous films. The stacking direction W of the electrode assembly 12, which has a stacking structure, is the direction in which the active material layers of the positive electrodes 12a and the negative electrodes 12b face each other.

Each positive electrode 12a has a positive tab 18 protruding from the edge, and each negative electrode 12b has a negative tab 20 protruding from the edge. The rechargeable battery 10 has a metal positive conductive plate 19, which is joined (for example, welded) to the group of the positive tabs 18, and a metal negative conductive plate 21, which is joined (for example, welded) to the group of the negative tab 20. The positive conductive plate 19 is electrically connected to a positive terminal 15, which is exposed from the lid 14 to the outside of the case 11. Like the positive terminal 15, the negative conductive plate 21 is electrically connected to a negative terminal 16, which is exposed to the outside of the case 11. Thus, the electrode assembly 12 is electrically connected to the positive terminal 15 and the negative terminal 16.

Next, the structure for welding the case body 13 and the lid 14 together will be described.

First, the structure of the case body 13 and the lid 14 will be described.

The lid 14 includes a pressure release valve 17. When the pressure in the case 11 reaches a release pressure, which is a predetermined pressure, the pressure release valve 17 ruptures to allow the inside and the outside of the case 11 to communicate each other, thereby preventing the pressure in the case 11 from being excessively increased. The release pressure of the pressure release valve 17 is set to a pressure that allows the pressure release valve 17 to rupture before a crack or a breakage occurs in the case 11 itself, the case body 13, or the lid 14.

The case body 13 has the bottom wall 13a and a circumferential wall 13b. The bottom wall 13a has a rectangular shape with a pair of long sides and a pair of short sides. The circumferential wall 13b extends from the four sides of the bottom wall 13a and has a tubular shape of a rectangular cross section. The circumferential wall 13b includes long side walls 131b respectively extending from the long sides of the bottom wall 13a and short side walls 132b respectively extending from the short sides of the bottom wall 13a. The opposite end faces of the electrode assembly 12 in the stacking direction W respectively face the inner surfaces of the long side walls 131b of the case body 13.

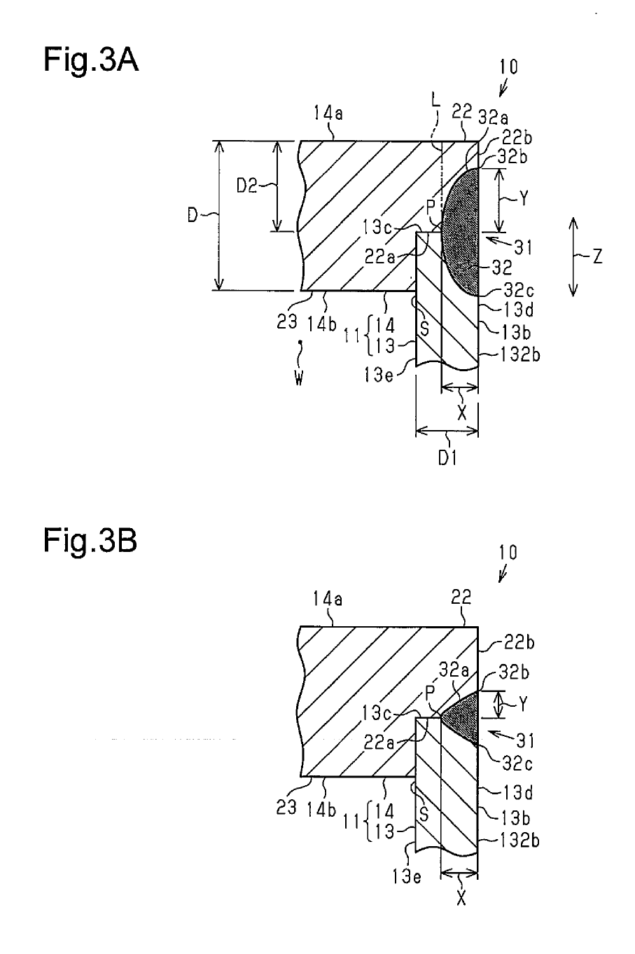

As shown in FIG. 3A, the direction orthogonal to the bottom wall 13a of the case body 13 and connecting the bottom wall 13a and the lid 14 by the shortest distance is defined as an extending direction Z of the case 11. The case body 13 has a case-side mating surface 13c, which abuts against the lid 14, on the opening end face of the circumferential wall 13b, which surrounds the opening S. The case-side mating surface 13c supports the lid 14. The case-side mating surface 13c is a flat surface that is orthogonal to the extending direction Z of the case 11 and parallel with the bottom wall 13a. The circumferential wall 13b has an inner circumferential surface 13e and an outer circumferential surface 13d, which are orthogonal to the case-side mating surface 13c and extend parallel with the extending direction Z of the case 11. In the circumferential wall 13b of the case body 13, the dimension of the straight line connecting the inner circumferential surface 13e and the outer circumferential surface 13d by the shortest distance is defined as a thickness D1 of the circumferential wall 13b. The thickness direction of the circumferential wall 13b is parallel with the bottom wall 13a.

The dimension of the lid 14 in the extending direction Z of the case 11 is defined as a thickness D of lid 14. The lid 14 is shaped as a rectangular flat plate. The lid 14 includes an outer end face 14a exposed to the outside in the extending direction Z of the case 11 and an inner end face 14b exposed to the inside of the case 11. The lid 14 has a rectangular plate-shaped insertion portion 23 and a flange portion 22 surrounding the insertion portion 23. The insertion portion 23 protrudes from the flange portion 22 toward the bottom wall 13a of the case body 13. The outer circumferential surface of the flange portion 22 constitutes an outer circumferential surface 22b of the lid 14.

The thickness D of the lid 14 is the sum of the thickness of the flange portion 22 and the thickness of the insertion portion 23. The thickness D of the lid 14 is a dimension of a straight line connecting the outer end face 14a and the inner end face 14b of the insertion portion 23 by the shortest distance. The thickness D of the lid 14 is thus greater than the thickness D2 of the flange portion 22. The thickness D2 of the flange portion 22 is greater than the thickness D1 of the circumferential wall 13b. Therefore, the following expression holds.

D>D2>D1 Expression

The insertion portion 23 of the lid 14 is inserted into the region surrounded by the circumferential wall 13b, and the flange part 22 of the lid 14 is supported by the case-side mating surface 13c of the circumferential wall 13b. In the present embodiment, a section of the inner end face 14b of the lid 14 that is located on the flange portion 22 constitutes a lid-side mating surface 22a, which faces the case-side mating surface 13c. The lid-side mating surface 22a is orthogonal to the extending direction Z and is a flat surface parallel with the bottom wall 13a. The case 11 has an abutting portion 31, which is a portion where the case-side mating surface 13c and the lid-side mating surface 22a are abutted against each other.

The case 11 has a welded portion 32 in the abutting portion 31. The welded portion 32 exists in the abutting portion 31 over the entire circumference of the case 11 and exists over the entire circumferential direction of the case 11. In the abutting portion 31, the case body 13 and the lid 14 are integrated by laser beam welding from the outside the case 11. In the present embodiment, laser beam welding using yttrium aluminum garnet (YAG) laser beam is performed by continuous wave (CW), in which laser beam is continuously output. In the present embodiment, laser beam welding is performed over the entire circumference of the case 11 under the condition of the laser spot diameter of 0.8 to 1 mm, the laser power of 2 to 5 kW, and the laser output speed of 1 to 3 m/min.

As shown in FIG. 3A, in a cross-sectional view of the case 11 along the extending direction Z, the welded portion 32 includes a first edge 32b, which is exposed from the outer surface of the lid 14 (specifically, the outer circumferential surface 22b), and a second edge 32c, which is exposed from the outer surface of the case body 13 (specifically, the outer circumferential surface 13d of the circumferential wall 13b). The first edge 32b is an edge closer to the outer end face 14a of the lid 14 and the second edge 32c is an edge closer to the bottom wall 13a of the case body 13 (farther from the outer end face 14a of the lid 14). In a cross-sectional view of the case 11 along the extending direction Z, the welded portion 32 has an interface 32a, which extends between the first edge 32b and the second edge 32c. The interface 32a of the welded portion 32 exists at the boundary between the welded portion 32 and the case 11. In a cross-sectional view of the case 11 along the extending direction Z, the welded portion 32 has a semicircular shape, specifically, a semi-elliptical shape that is elongated in the extending direction Z. That is, the interface 32a of the welded portion 32 has an arcuate shape that is curved from the first edge 32b and the second edge 32c toward the case-side mating surface 13c and the lid-side mating surface 22a. The interface 32a of the welded portion 32 has a shape that is most distant from the outer circumferential surface 13d of the circumferential wall 13b and the outer circumferential surface 22b of the flange portion 22 in the vicinity of the case-side mating surface 13c and the lid-side mating surface 22a. The apex P of the interface 32a is located at the abutting portion 31 (the boundary between the case-side mating surface 13c and the lid-side mating surface 22a). In a cross-sectional view taken along the extending direction Z of the case 11, the welded portion 32 has a semi-elliptical shape elongated in the extending direction Z and the apex P of the interface 32a is located at the abutting portion 31 at any location in the circumferential direction of the case 11. The surface of the welded portion 32 exposed from the outer surface of the case 11 is continuous with the outer circumferential surface 13d of the case body 13 and the outer circumferential surface 22b of the flange portion 22.

A tangent L passing through the apex P of the interface 32a and extending in the extending direction Z of the case 11 is orthogonal to the case-side mating surface 13c and the lid-side mating surface 22a. In other words, in the cross-sectional view of the case 11 along the extending direction Z, the welded portion 32 is orthogonal to the case-side mating surface 13c and the lid-side mating surface 22a at the section passing through the abutting portion 31. The direction along the case-side mating surface 13c and the lid-side mating surface 22a is defined as a plane direction. In the present embodiment, the plane direction is also the thickness direction of the circumferential wall 13b. In this plane direction and the thickness direction of the circumferential wall 13b, the maximum dimension from the surface of the welded portion 32 to the interface 32a is defined as a weld depth X. In the present embodiment, the weld depth X of the welded portion 32 is the dimension at the boundary between the case-side mating surface 13c and the lid-side mating surface 22a. The weld depth X of the welded portion 32 is greater than half the thickness D1 of the circumferential wall 13b, and the welded portion 32 is formed by using a dimension exceeding half the thickness of the circumferential wall 13b.

Further, in a direction along the surface of the welded portion 32 exposed from the outer surface of the case 11 (in other words, in a direction along the outer circumferential surface 13d of the case body 13 and the outer circumferential surface 22b of the flange portion 22 or in the extending direction Z of the case 11), the dimension from the abutting portion 31 (the boundary between the case-side mating surface 13c and the lid-side mating surface 22a) to the first edge 32b or the dimension from the abutting portion 31 (the case-side mating surface 13c and the lid-side mating surface 22a) to the second edge 32c is defined as a weld width Y. In the present embodiment, the dimension from the abutting portion 31 to the first edge 32b is defined as the weld width Y. The dimension from the abutting portion 31 to the first edge 32b is equal to the dimension from the abutting portion 31 to the second edge 32c. The width of the entire welded portion 32 is thus represented by 2Y. In the present embodiment, the weld width Y is greater than weld depth X. Therefore, the following expression holds.

Y/X>1 Expression

The relationship between the weld depth X and weld width Y in the above expression is established at any location in the circumferential direction of case 11.

Next, an operation of the rechargeable battery 10 will be described.

FIG. 3B shows a welded portion 32 of a comparative example. The welded portion 32 of this comparative example has the same weld depth X as that of the present embodiment and a shorter weld width Y than that of the present embodiment. In a cross-sectional view of the case 11 along the extending direction Z, the length of the interface 32a of the present embodiment is greater than the length of the interface 32a of the comparative example. In the comparative example, the laser spot diameter is 0.6 mm, the laser power is 2 to 5 kW, and the laser output speed is 0.5 m/min.

An electrical storage module 30 shown in FIG. 2 has a plurality of the rechargeable batteries 10 described above. In the present embodiment, the rechargeable batteries 10 are arranged in a single row. The long side walls 131b of any adjacent rechargeable batteries 10 face each other in the arrangement direction of the rechargeable batteries 10.

The electrical storage module 30 has two restraint plates 41, which hold the rechargeable batteries 10 from the opposite sides in the arrangement direction of the rechargeable batteries 10. The rechargeable batteries 10 receive a restraining load through the restraint plates 41. In the present embodiment, the restraint plates 41 are made of metal. The restraint plates 41 are positioned on the outer side in the arrangement direction of the rechargeable batteries 10 located at the outermost positions among the arranged rechargeable batteries 10 and function as end plates.

Through bolts 43 are inserted through the four corners of each restraint plate 41 and a nut 44 is screwed to each through bolt 43. This integrates all the rechargeable batteries 10 while holding the rechargeable batteries 10 in the stacking direction W of the electrode assembly 12, which is the same as the arrangement direction of the rechargeable batteries 10. As shown in FIG. 3A, each rechargeable battery 10 is restrained in the stacking direction W. The restraint applies restraining load to the long side walls 131b of the case body 13 in each rechargeable battery 10 and applies load to each electrode assembly 12 through the long side wall 131b.

The above-described embodiment has the following advantages.

(1) The welded portion 32 of the case 11 is provided over the entire circumference of the case 11 in a state in which the expression Y/X>1 is satisfied about the weld depth X and the weld width Y. Therefore, as compared with a case in which the welded portion 32 is configured not to satisfy the expression Y/X>1, the length of the interface 32a in the cross-sectional view along the extending direction Z of the case 11 is increased. As a result, when a load is applied to the welded portion 32, the load per unit area on the welded portion 32 is reduced, which increases the strength of the welded portion 32. Therefore, even if stress is repeatedly generated in the welded portion 32 due to repetitive expansion and contraction of the electrode assembly 12 in the stacking direction W of the electrode assembly 12 in the case 11, the welded portion 32 will not be peeled off the case 11 and the welded portion 32 is unlikely to be damaged. In addition, even if the internal pressure of the case 11 increases, generating stress in the extending direction Z in the case 11, the welded portion 32 is not sheared from the interface 32a, and the welded portion 32 is unlikely to be damaged. Further, since the welded portion 32, which satisfies the expression Y/X>1, exists over the entire circumference of the case 11, the strength of the welded portion 32 is increased at any location in the circumferential direction.

(2) The weld depth X of the present embodiment is set at the boundary between the case-side mating surface 13c and the lid-side mating surface 22a. In the cross-sectional view of the case 11 along the extending direction Z, the interface 32a of the welded portion 32 is orthogonal to the case-side mating surface 13c and the lid-side mating surface 22a at the section passing through the abutting portion 31. More specifically, the tangent L of the interface 32a at the position corresponding to the abutting portion 31 is orthogonal to the case-side mating surface 13c and the lid-side mating surface 22a. That is, in the cross-sectional view along the extending direction Z, the welded portion 32 is formed to have an elongated shape in the extending direction Z to prevent the weld width Y from being reduced. This increases the strength of the welded portion 32.

(3) In the cross-sectional view of the case 11 along the extending direction Z, the interface 32a of the welded portion 32 extends arcuately between the first edge 32b and the second edge 32c of the welded portion 32. This prevents the weld width Y from being reduced, thereby increasing the strength of the welded portion 32.

(4) In the cross-sectional view of the case 11 along the extending direction Z, the welded portion 32 has a semi-elliptical shape, and the dimension in the extending direction Z of the welded portion 32 is greater than the dimension in the plane direction of the case-side mating surface 13c and the lid-side mating surface 22a. That is, in the cross-sectional view along the extending direction Z, the welded portion 32 is formed to have an elongated shape in the extending direction Z to increase the length of the interface 32a. This increases the strength of the welded portion 32.

(5) The welded portion 32 is formed by irradiating the circumferential wall 13b and the lid 14 with laser beam from the outer circumference. Therefore, the surface of the welded portion 32 is exposed from the outer circumferential surface 13d of the circumferential wall 13b and the outer circumferential surface 22b of the flange portion 22 at the lid 14. The thickness D of the lid 14 is greater than the thickness D1 of the circumferential wall 13b. More specifically, the thickness D2 of the flange portion 22 of the lid 14 is greater than the thickness D1 of the circumferential wall 13b. The weld depth X of the welded portion 32 is the dimension in the thickness direction of the circumferential wall 13b, and the weld depth X is limited by the thickness of the circumferential wall 13b. However, by making the thickness D2 of the flange portion 22 of the lid 14 greater than the thickness D1 of the circumferential wall 13b, a sufficient weld width Y of the welded portion 32 is ensured in the extending direction Z of the case 11, so that a sufficient weld strength is ensured without increasing the thickness of the circumferential wall 13b. Therefore, it is possible to prevent the energy density of the rechargeable battery 10 from being reduced due to an increase in the thickness of the circumferential wall 13b.

(6) The electrical storage module 30 has a plurality of the rechargeable batteries 10 arranged in a row and restrained in the same arrangement direction by a pair of the restraint plates 41. That is, the electrode assembly 12 of the rechargeable battery 10 is restrained in the stacking direction W of the electrode assembly 12. Therefore, even if expansion and contraction of the electrode assembly 12 in the stacking direction W occur due to charging and discharging of the electrode assembly 12, the restraint by the restraint plates 41 limits the generation of stress in the stacking direction W in the welded portion 32, so that the welded portion 32 is unlikely to be damaged by the stress in the stacking direction W. When the internal pressure of the case 11 increases, a force acts on the case 11 in the direction of separating the lid 14 from the case body 13 (the extending direction Z of the case 11), but not in the restraining direction by the restraint plates 41. (5) The welded portion 32 is formed by horizontal welding, in which the circumferential wall 13b and the lid 14 are irradiated with laser beam from the outer circumference. Therefore, when a force in a direction of separating the lid 14 from the case body 13 acts on the case 11, the force acts in a direction of shearing the welded portion 32 from the interface 32a. However, since the weld width Y is ensured along the extending direction Z of the case 11 and a sufficient length of the interface 32a is also ensured in the extending direction Z, the strength of the welded portion 32 in the extending direction Z of the case 11 is increased, so that the welded portion 32 is not easily damaged due to the force acting in the extending direction Z (shearing force). Therefore, the welded portion 32, which has a sufficient length of the interface 32a in the extending direction Z, is preferably used in the welded portion 32 formed by the horizontal welding.

(7) The thickness D of the lid 14 and the thickness D2 of the flange portion 22 are greater than the thickness D1 of the circumferential wall 13b. Also, incorporating the pressure release valve 17, the lid 14 has a certain thickness to form the pressure release valve 17. Thus, the lid 14 has a shape suitable for ensuring the weld width Y that is greater than the weld depth X. Therefore, the lid 14, which includes the pressure release valve 17, is suitable for forming the welded portion 32 so as to satisfy the expression Y/X>1.

The above-described embodiment may be modified as follows.

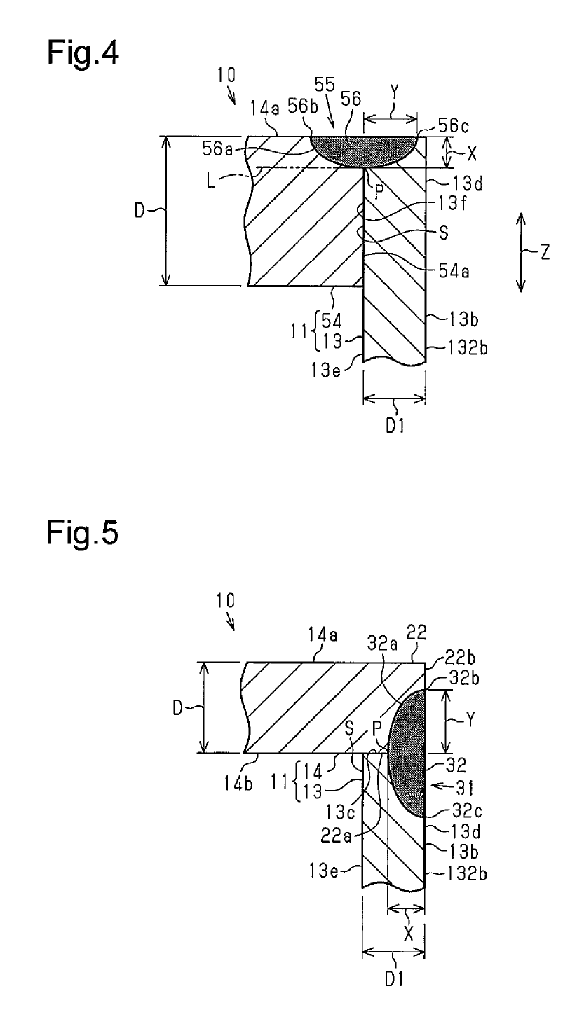

The shapes of the case body 13 and the lid 14 may be changed to change the arrangement of the welded portion 32 with respect to the case 11. That is, as in a second embodiment shown in FIG. 4, a flat plate-shaped lid 54 is employed that has no flange portion 22 and has a size that can be fitted inside the circumferential wall 13b of the case body 13. In this case, the thickness D of the lid 54 is greater than the thickness D1 of the circumferential wall 13b, and the expression D>D1 holds. The lid 54 is fitted inside the circumferential wall 13b of the case body 13. In this case, the circumferential wall 13b has a case-side mating surface 13f on its inner circumferential surface, and the lid 54 has a lid-side mating surface 54a on its outer circumferential surface. A welded portion 56 is formed on an abutting portion 55 located at the boundary between the case-side mating surface 13f and the lid-side mating surface 54a. The welded portion 56 ranges over the opening end face of the case body 13 and the outer end face 14a of the lid 54. Further, the welded portion 56 exists over the entire circumference of the case 11.

In this case, in a sectional view of the case 11 along the extending direction Z, the welded portion 56 has a first edge 56b, which is exposed from the outer end face 14a of the lid 54, and a second edge 56c, which is exposed from the opening end face of the case body 13. In a cross-sectional view of the case 11 along the extending direction Z, the welded portion 56 has an interface 56a, which extends between the first edge 56b and the second edge 56c. The interface 56a of the welded portion 56 exists at the boundary between the welded portion 56 and the case 11. In a cross-sectional view of the case 11 along the extending direction Z, the interface 56a of the welded portion 56 has a semi-elliptical shape elongated in the thickness direction of the circumferential wall 13b. The interface 56a of the welded portion 56 has an arcuate shape that is curved from the first edge 56b and the second edge 56c toward the case-side mating surface 13f and the lid-side mating surface 54a. The interface 56a of the welded portion 56 has a shape that is most distant from the outer end face 14a of the lid 54 and the opening end face of the case body 13 in the vicinity of the lid-side mating surface 54a and the case-side mating surface 13f. The apex P of the interface 56a is located at the boundary between the lid-side mating surface 54a and the case-side mating surface 13f (the abutting portion 55). The tangent L passing through the apex P is orthogonal to the lid-side mating surface 54a and the case-side mating surface 13f.

In a cross-sectional view of the case 11 along the extending direction Z, the maximum dimension from the surface of the welded portion 56 exposed from the case 11 to the interface 32a is defined as a weld depth X in a plane direction along the case-side mating surface 13f and the lid-side mating surface 54a. In other words, the weld depth X is the maximum dimension from the surface of the welded portion 56 to the interface 56a in the extending direction Z of the case 11. Further, if the dimension along the outer end face 14a of the lid 54 and the opening end face of the circumferential wall 13b and in the surface of the welded portion 56 in a direction orthogonal to the abutting portion 55 is defined as a weld width Y, the expression Y/X>1 holds. This expression holds at any location in the circumferential direction of the case 11 in the welded portion 32.

The welded portion 56, which has the above-described configuration, increases the lengths of the weld width Y and the interface 56a along the stacking direction W of the electrode assembly 12 and increases the strength of the welded portion 56 against the load in the stacking direction W of the electrode assembly 12.

In the first and second embodiments, in the cross-sectional view of the case 11 along the extending direction Z, the shapes of the interfaces 32a, 56a of the welded portions 32, 56 may be changed as necessary as long as the expression Y/X>1 holds.

For example, the tangent L passing through the apex P of the interfaces 32a, 56a does not necessarily need to be orthogonal to the lid-side mating surfaces 22a, 54a and the case-side mating surfaces 13c, 13f. The interfaces 32a, 56a do not necessarily need to be arcuate but may be curved gently.

In the first embodiment, the lid 14 does not necessarily need to have the insertion portion 23 but may be shaped like a flat plate, for example, as in a third embodiment shown in FIG. 5. In this case, the lid 14 has a lid-side mating surface 22a on the outer circumferential portion of the inner end face 14b, and the lid-side mating surface 22a may be abutted against and welded to the case-side mating surface 13c of the case body 13. In this case also, the thickness D of the lid 14 is greater than the thickness D1 of the circumferential wall 13b, and the expression D>D1 holds.

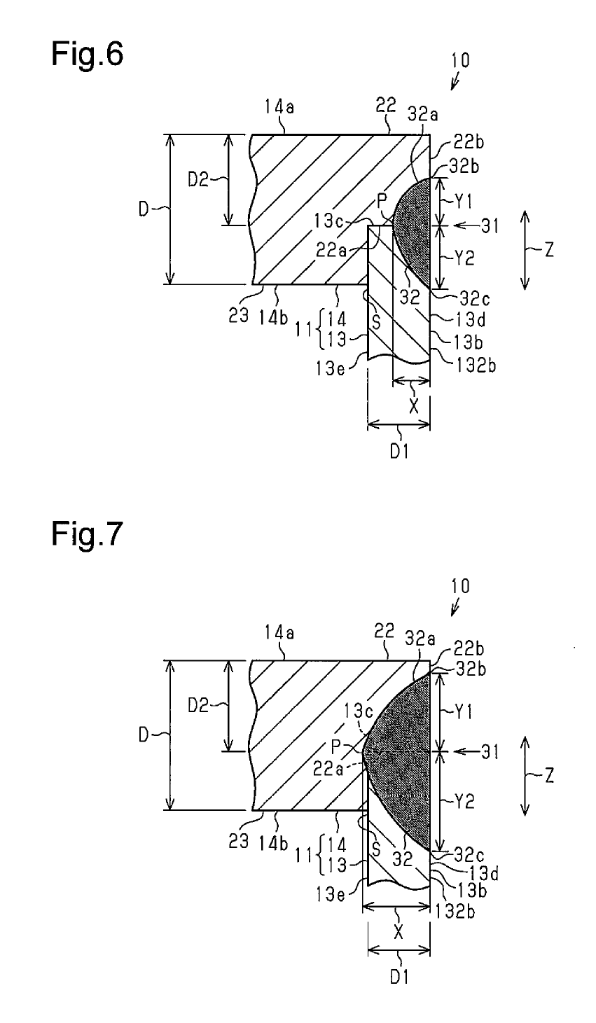

In the first embodiment described above, the welded portion 32 does not necessarily need to have a semi-elliptical shape in a cross-sectional view of the case 11 along the extending direction Z of the case 11. For example, as in a fourth embodiment shown in FIG. 6, the welded portion 32 may be formed into such a shape that a weld width Y1, which is the dimension from the abutting portion 31 to the first edge 32 b in the extending direction Z, is different from a weld width Y2, which is the dimension from the abutting portion 31 to the second edge 32c in the extending direction Z. In the fourth embodiment, the weld widths Y1 and Y2 are both greater than the weld depth X. The length of the section of the interface 32a of the welded portion 32 that extends between the abutting portion 31 and the first edge 32b may be different from the length of the section that extends between the abutting portion 31 and the second edge 32c.

In the above-described first embodiment, for example, the interface 32a of the welded portion 32 may extend to a position that is beyond and inward of the abutting portion 31 in the case 11 in the plane direction (the thickness direction of the circumferential wall 13b) as in a fifth embodiment shown in FIG. 7. In this case, the weld depth X is the dimension from the surface of the welded portion 32 to the interface 32a, which is located closer to the center of the case 11 than the abutting portion 31. Even in this case, the shape of the interface 32a of the welded portion 32 satisfies the expressions Y1/X>1 and Y2/X>1.

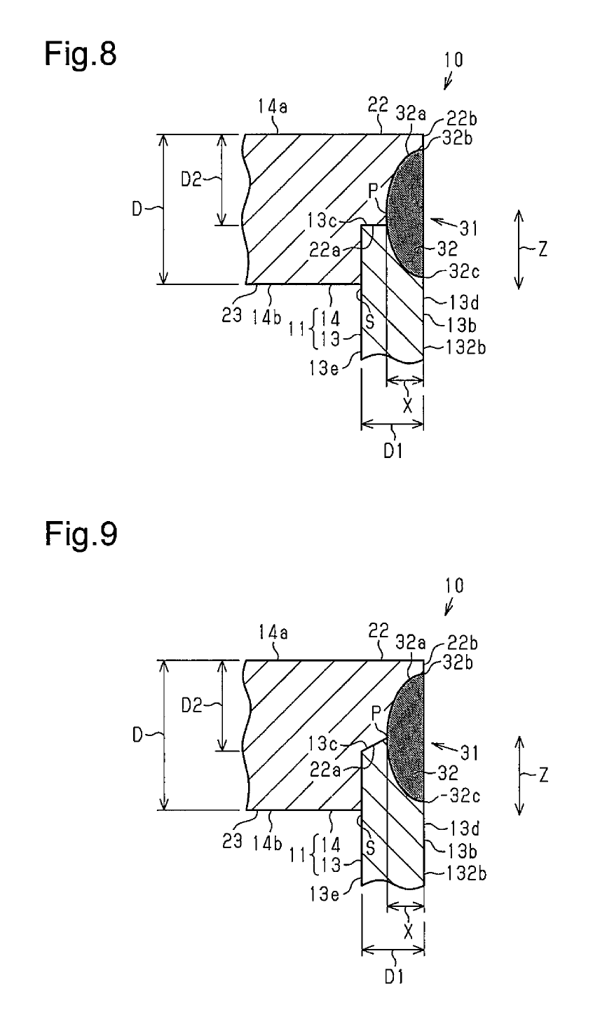

In the above-described first embodiment, the weld depth X of the welded portion 32 does not necessarily need to be the dimension at the boundary between the case-side mating surface 13c and the lid-side mating surface 22a. For example, as in a sixth embodiment shown in FIG. 8, the weld depth X may be the dimension at a section closer to the outer end face 14a of the lid 14 than the boundary between the case-side mating surface 13c and the lid-side mating surface 22a. Alternatively, although not illustrated, the weld depth X may be the dimension at a section closer to the bottom wall 13a of the case body 13 than the boundary portion between the case-side mating surface 13c and the lid-side mating surface 22a.

In the above-described first embodiment, the case-side mating surface 13c and the lid-side mating surface 22a may be flat surfaces that are not orthogonal to the extending direction Z of the case 11 but inclined with respect to a plane orthogonal to the extending direction as in a seventh embodiment shown in FIG. 9. In this case, the weld depth X is the maximum dimension from the surface of the welded portion 32 to the interface 32a in the thickness direction of the circumferential wall 13b.

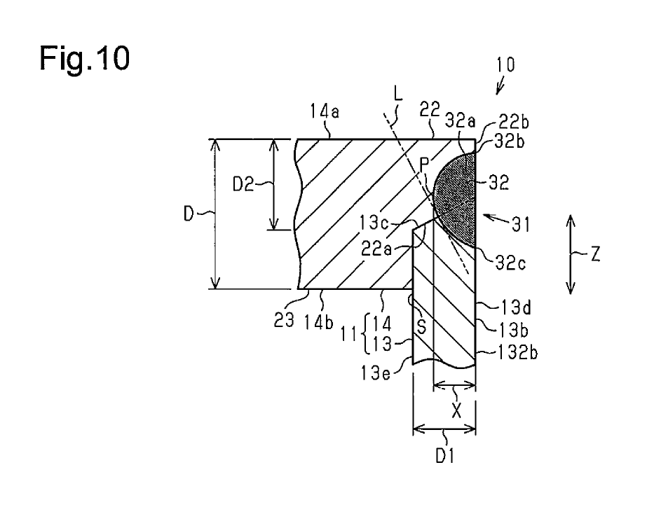

In the above-described first embodiment, the case-side mating surface 13c and the lid-side mating surface 22a may be flat surfaces that are not orthogonal to the extending direction Z of the case 11 but inclined with respect to a plane orthogonal to the extending direction as in an eighth embodiment shown in FIG. 10. Then, the interface 32a of the welded portion 32 may be orthogonal to the case-side mating surface 13c and the lid-side mating surface 22a at the section passing through the abutting portion 31. More specifically, the tangent L of the interface 32a at the position corresponding to the abutting portion 31 may be orthogonal to the case-side mating surface 13c and the lid-side mating surface 22a.

In the above-described embodiments, the method for applying restraining load to the electrical storage module 30 is not limited to fastening of the restraint plates 41 to each other, but may be other methods.

In the above-described embodiments, the electrode assembly 12 is not limited to a stacked type, but may also be a spiral type, in which strip-shaped positive electrodes and strip-shaped negative electrodes are wound and stacked in layers. In the case of a spiral type electrode assembly, the stacking direction of the electrode assembly is the direction in which the surfaces overlap.

The tubular shape of the case body 13 may have a shape other than the shape of a rectangular tube, and may be a cylindrical or the shape of a hexagonal tube. The shapes of the lids 14, 54 are also changed in accordance with the tubular shape of the case body 13.

In the above-described embodiments, the rechargeable battery 10 is a lithium-ion rechargeable battery. However, the rechargeable battery 10 may be a rechargeable battery of another type. That is, any configuration may be employed as long as ions move between the positive-electrode active material layer and the negative-electrode active material layer, and the positive-electrode active material layer and the negative-electrode active material layer give and receive electric charge. Also, each of the above-described embodiments may be applied to a capacitor as an electrical storage device.

### DESCRIPTION OF THE REFERENCE NUMERALS

D . . . Thickness of Lid; D1 . . . Thickness of Circumferential wall; S . . . Opening; W . . . Stacking Direction; X . . . Weld depth; Y, Y1, Y2 . . . Weld width; Z . . . Extending Direction; 10 . . . Rechargeable Battery; 11 . . . Case; 12 . . . Electrode Assembly; 13 . . . Case Body; 13b . . . Circumferential wall; 13c, 13f . . . Case-Side Mating surface; 13d, 22b . . . Outer Circumferential Surface; 14, 54 . . . Lid; 14a . . . Outer End Face; 14b . . . Inner End Face; 22a, 54a . . . Lid-Side Mating surface; 31, 55 . . . Abutting Portion; 32, 56 . . . Welded portion; 32a, 56a . . . Interface; 32b, 56b . . . First Edge; 32c, 56c . . . Second Edge

1-10. (canceled)

11. An electrical storage device comprising an electrode assembly and a case, which accommodates the electrode assembly, wherein
the case includes
a tubular case body, which has a bottom wall and an opening, and
a lid, which closes the opening,
the case body includes a circumferential wall,
the circumferential wall has an opening end face, which surrounds the opening, and an outer circumferential surface,
the opening end face has a case-side mating surface, which abuts against the lid,
the lid includes
an inner end face, which has a lid-side mating surface, which faces the case-side mating surface, and
an outer circumferential surface, which surrounds the inner end face,
the case has a welded portion existing over an entire circumference of the case at an abutting portion, which is a portion where the case-side mating surface and the lid-side mating surface are abutting against each other,
the welded portion has a surface, which is exposed from the outer circumferential surface of the circumferential wall and the outer circumferential surface of the lid,
a direction that connects the bottom wall of the case body and the lid by the shortest distance is defined as an extending direction of the case,
in a cross-sectional view of the case along the extending direction, the welded portion has an interface existing at a boundary of the welded portion with the case body and the lid,
a maximum dimension from the surface of the welded portion to the interface in a thickness direction of the circumferential wall is defined as a weld depth X,
a dimension from the abutting portion to an edge of the welded portion in a direction along the extending direction is defined as a weld width Y, and
the welded portion is configured to satisfy an expression Y/X>1 over the entire circumference of the case.

12. The electrical storage device according to claim 11, wherein
the weld depth X is a dimension at the case-side mating surface and the lid-side mating surface, and
the interface is orthogonal to the case-side mating surface and the lid-side mating surface at a section passing through the abutting portion.

13. The electrical storage device according to claim 11, wherein
the welded portion includes
a first edge, which is exposed from an outer surface of the lid, and
a second edge, which is exposed from an outer surface of the case body, and
the interface extends arcuately between the first edge and the second edge.

14. The electrical storage device according to claim 11, wherein, in a cross-sectional view taken along the extending direction of the case, the welded portion has a semi-elliptical shape elongated in the extending direction.

15. The electrical storage device according to claim 11, wherein
the electrode assembly has stacked electrodes of different polarities, and
the electrical storage device is one of a plurality of electrical storage devices, which are restrained in a state of being arranged in a stacking direction of the electrodes.

16. The electrical storage device according to claim 11, wherein
a dimension in the thickness direction of the circumferential wall is defined as a thickness D1,
a dimension of the lid along the extending direction is defined as a thickness D, and
the case body and the lid are configured to satisfy an expression D>D1.

17. The electrical storage device according to claim 11, wherein
the lid includes an insertion portion, which is inserted into a region surrounded by the circumferential wall, and a flange portion surrounding the insertion portion,
the flange portion has the lid-side mating surface and an outer circumferential surface, which forms the outer circumferential surface of the lid,
a dimension of the lid along the extending direction at a section corresponding to the insertion portion is defined as a thickness D,
a dimension of the flange portion along the extending direction is defined as a thickness D2, and
the lid is configured to satisfy an expression D>D2>(D−D2).

18. The electrical storage device according to claim 11, wherein
the lid includes an insertion portion, which is inserted into a region surrounded by the circumferential wall, and a flange portion surrounding the insertion portion,
the flange portion has the lid-side mating surface and an outer circumferential surface, which forms the outer circumferential surface of the lid,
a dimension of the lid along the extending direction at a section corresponding to the insertion portion is defined as a thickness D,
a dimension of the flange portion along the extending direction is defined as a thickness D2,
a dimension in the thickness direction of the circumferential wall is defined as a thickness D1, and
the lid and the case body are configured to satisfy an expression D>D2>D1.

19. The electrical storage device according to claim 11, wherein the weld depth X is greater than half a dimension in the thickness direction of the circumferential wall.

20. The electrical storage device according to claim 11, wherein the electrical storage device is a rechargeable battery.
